(19) United States
(12) Patent Application Publication
(10) Pub. No.: US 2006/0001410 A1
(43) Pub. Date: Jan. 5, 2006

(54) Power supply apparatus using synchronous rectified step-down converter

(76) Inventors: Hiroyuki Ishikawa, Ukyo-Ku (JP); Masao Nakajima, Ukyo-Ku (JP)

Correspondence Address: CANTOR COLBURN, LLP, 55 GRIFFIN ROAD SOUTH, BLOOMFIELD, CT, 06002, US

(21) Appl. No.: 11/171,828

(22) Filed: Jun. 30, 2005

(30) Foreign Application Priority Data
Jul. 2, 2004 (JP) JP2004-196751
May 13, 2005 (JP) JP2005-141442

(51) Int. Cl. G05F 1/40

(52) U.S. Cl. 323/282

(57) ABSTRACT

A power supply apparatus includes a step-down converter, a regulator, a PWM signal generator and a bypass switch and is operated by switching between the step-down converter and the bypass switch for output. While an input voltage is output unmodified by the bypass witch, an offset circuit offsets an error voltage which is an output of the regulator se that a synchronous rectification switch is turned off. When an output of the power supply apparatus is switched from the bypass switch to the step-down converter and a step-down operation of the step-down converter is resumed, the synchronous rectification switch is gradually brought from an off state to an on state by an offset applied to the error voltage.

### BACKGROUND OF THE INVENTION

1. Field of the Invention

The present invention relates to a power supply apparatus using a synchronous rectified step-down converter and a power amplifier apparatus using the power supply apparatus.

2. Description of the Related Art

In small-sized information terminals used in recent years such as a cell phone and a personal digital assistant (PDA), it is necessary to reduce power consumption in internal circuits as much as possible for extended operating time. Small-sized information terminals often use a Li-ion battery. For example, the output voltage of the battery is about 3.5V. When fully charged, the battery voltage is about 4.2V. Circuits used inside the small-sized information terminals do not necessarily require the battery voltage itself as a power source.

For example, the power supply voltage required in a power amplifier used in a cell phone depends on its output power and is approximately in a range of 0.6V-3.5V. Using the battery voltage of about 3.5V unmodified when the power supply voltage required in the power amplifier is only 1V will result in more power than is needed being consumed. Accordingly, a step-down converter such as a switching regulator is used as a power supply apparatus to supply a power supply voltage lower than a battery voltage to a circuit to be driven by a voltage lower than the battery voltage.

The power supply apparatus using the switching regulator affects the operation of the circuit connected to it significantly if an output voltage of the apparatus is unstable. Therefore, stabilization of the output is an important technical task. For example, patent documents No. 1 and No. 2 propose technologies for improving the stability of the output of the power supply apparatus.

[patent document No. 1]

JP 2004-80985

[patent document No. 2]

JP 2004-56982

Step-down converters such as those proposed in the related art are not without power consumption due to inductors and switching elements. Accordingly, one conceivable method is to suspend the switching operation of the step-down converter when there is no need to lower the battery voltage, i.e., the input voltage, and outputting the input voltage unmodified by bypassing the step-down converter using a bypass circuit.

Under such circumstances, the inventor of the present invention has come to be aware of the following problems. When the step-down operation of the step-down converter is resumed in a state in which the input voltage is output unmodified by bypassing the step-down converter by a bypass circuit, the switching operation is started in a state in which an output terminal of the step-down converter is fixed at a high voltage. As a result, a synchronous rectification switch is abruptly turned on, causing overshoot or ringing and making the output voltage unstable.

### SUMMARY OF THE INVENTION

The present invention has been made with the aforementioned problem in mind and its object is to provide a power supply apparatus in which the stability of output voltage is improved.

In order to solve the aforementioned problem, the present invention according to one aspect provides a power supply apparatus comprising: a synchronous rectified step-down converter in which a main switch and a synchronous rectification switch are alternately turned on and off; and a voltage generating circuit provided in a route separate from the step-down converter, wherein one of the step-down converter and the voltage generating circuit is selected to output a desired voltage, and the step-down converter turns the synchronous rectification switch off while the voltage generating circuit is being selected.

According to this aspect, the synchronous rectification switch starts its switching operation in an off state, when the output of the power supply apparatus is switched from the voltage of the voltage generating circuit to the voltage of the step-down converter. Therefore, the synchronous rectification switch is prevented from continuing to be turned on for a prolonged period of time, and a stable output voltage with reduced overshoot or ringing is obtained.

The present invention according to another aspect also provides a power supply apparatus. The apparatus according to this aspect comprises: a synchronous rectified step-down converter in which a main switch and a synchronous rectification switch are alternately turned on and off; a voltage generating circuit which outputs a voltage higher than the step-down converter; a regulator which outputs an error voltage so that an output voltage of the step-down converter approximates a predetermined reference voltage; and a pulse width modulator which varies a duty ratio with which the main switch and the synchronous rectification switch are turned on and off, in accordance with the error voltage, wherein one of the step-down converter and the voltage generating circuit is selected to output a desired voltage. The regulator offsets the error voltage while the voltage generating circuit is being selected, in a direction in which the synchronous rectification switch is turned off.

According to this aspect, by offsetting the error voltage of the regulator when the output voltage is switched from the voltage generating circuit to the step-down converter, the synchronous rectification switch starts its switching operation in an off state. As a result, the synchronous rectification switch is prevented from continuing to be turned on for a prolonged period of time and a stable output voltage with reduced overshoot is obtained.

The voltage generating circuit may include a bypass circuit which short-circuits an output terminal of the step-down converter to an input terminal thereof. By short-circuiting the output terminal to the input terminal, the input voltage is output unmodified from the power supply apparatus. The output voltage is in this case is higher than the output voltage of the step-down converter. By offsetting the error voltage of the regulator when the step-down converter resumes its step-down operation in a state in which the output terminal is fixed at a high voltage, the synchronous rectification switch starts is switching operation in an off state. As a result, the synchronous rectification switch is prevented from continuing to be turned on for a prolonged period of time and a stable output voltage with reduced overshoot is obtained.

The regulator may be provided with an offset circuit which offsets the error voltage in synchronization with an externally supplied selection signal for selecting the step-down converter or the voltage generating circuit. By generating an offset voltage in synchronization with the selection signal for selecting the step-down converter or the voltage generating circuit, the switching operation of the synchronous rectification switch is accurately controlled.

The offset circuit may gradually decrease the amount of offset applied to the error voltage in response to the switching from the voltage generating circuit to the step-down converter.

By gradually decreasing the amount of offset applied to the error voltage after switching the output of the power apparatus from the voltage generating circuit to the step-down converter, the duty ratio of a signal controlling the synchronous rectification switch gradually varies with time. As a result, the output voltage also varies gradually so that the output voltage is stabilized without causing variation such as overshoot.

The regulator may comprise: a first operational amplifier which adds a predetermined offset voltage to the output voltage of the step-down converter and outputs a resultant voltage; a second operational amplifier which amplifies a difference between an output voltage of the first operational amplifier and the reference voltage; and a filter circuit which removes low-frequency components of an output voltage of the second operational amplifier. The offset voltage maybe generated based on a signal which switches between the step-down converter and the voltage generating circuit.

In this case, the error voltage output from the second operational amplifier varies gradually due to the filter circuit. Accordingly, the same function as gradual variation of the offset voltage is achieved.

The filter circuit may comprise: a resistor provided between a first input terminal of the second operational amplifier and the first operational amplifier; and a capacitor provided between an output terminal of the second operational amplifier and a second input terminal thereof.

By forming an integration circuit by the second operational amplifier, the resistor and the capacitor, the error amplifier and the filter circuit are integrally formed.

The present invention according to still another aspect provides a power amplifier apparatus. The power amplifier apparatus is provided with a power amplifier for power amplification and the aforementioned power supply apparatus for supplying power to the power amplifier.

According to this aspect, the power supply voltage supplied to the power amplifier in the power amplifier apparatus is stabilized and the output voltage of the power amplifier is stabilized accordingly.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a circuit diagram illustrating the structure of a power supply apparatus according to an embodiment of the present invention.

FIGS. 2A-2F show time waveforms of voltages occurring at respective terminals when the offset function of the power supply apparatus of FIG. 1 is not activated.

FIGS. 3A-3F show time waveforms of voltages occurring at respective terminals when the offset function of the power supply apparatus of FIG. 1 is activated.

FIG. 4 is a circuit diagram illustrating the structure of the power supply apparatus according to the embodiment and illustrates an example of circuit in which a regulator is provided with the offset function.

FIGS. 5A-5C show time waveforms of voltages occurring at respective terminals of the power supply apparatus of FIG. 4.

FIG. 6 illustrates the structure of a power amplifier apparatus for a cell phone produced by connecting a power amplifier to the power supply apparatus according to the embodiment.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

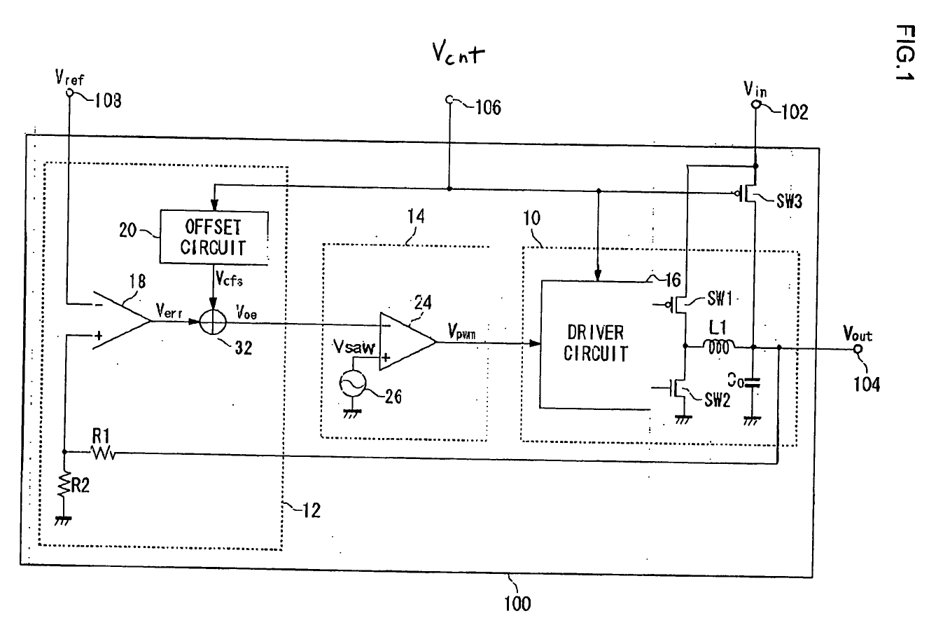

FIG. 1 is a circuit diagram illustrating a power supply apparatus 100 according to an embodiment of the present invention. In the following diagrams, like numerals are employed to designate like components and the description thereof is omitted.

Firstly, an overview of the power supply apparatus 100 will be given.

The power supply apparatus 100 includes a step-down converter 10 and a bypass switch SW3. The bypass switch SW3 functions as a voltage generating circuit provided parallel with the step-down converter 10. The power supply apparatus 100 selects either the step-down converter 10 or the bypass switch SW3 to output a desired voltage. As such, the power supply apparatus 100 operates in one of two modes depending on the desired voltage to be supplied to a load. In a first mode of operation, the step-down converter 10 lowers an input voltage Vin for output. In a second mode of operation, the bypass switch SW3 bypasses the step-down converter 10 so as to output the input voltage Vin unmodified. Hereinafter, these modes of operation will be respectively referred to as a step-down mode and a bypass mode.

In general, the step-down converter incurs power loss due to inductors and switching elements used therein. Therefore, when there is no need to lower a voltage, the power supply apparatus 100 operates to bypass the step-down converter 10 and suspend its switching operation and to output the input voltage unmodified. As such, the power supply apparatus 100 according to the embodiment switchably uses the step-down mode and the bypass mode. The voltage output while the bypass switch SW3 is turned on is higher than the voltage output by the step-down converter.

Input and output terminals provided in the power supply apparatus 100 include an input terminal 102, an output terminal 104, a control terminal 106 and a reference voltage terminal 108. Voltages applied to the terminals or voltages occurring at the terminals will be respectively referred to as an input voltage Vin, an output voltage Vout, a control voltage Vcnt and a reference voltage Vref.

In the step-down mode, the power supply apparatus 100 lowers the input voltage Vin and outputs the lowered voltage to the output terminal 104. The output voltage Vout is controlled by the reference voltage Vref. In the bypass mode, the power supply apparatus 100 outputs the input voltage Vin unmodified regardless of the reference voltage Vref. Mode switching is prompted by the control voltage Vcnt which is input to the apparatus from an external source.

The power supply apparatus 100 includes the step-down converter 10, a regulator 12, a Pulse width Modulation (FWM) signal generator 14 and a bypass switch SW3.

The regulator 12 includes an error amplifier 18 and resistors R1 and R2. The regulator 12 adjusts an error voltage Verr by feedback so that a relation Vout=Vref(R1+R2)/R2-holds between the output voltage Vout and the reference voltage Vref. The regulator 12 further includes an offset circuit 20 for generating an offset voltage Vofs and an adder 32. The regulator 12 adds the error voltage Verr and the offset voltage Vofs so as to output an offset error voltage Voe. The offset voltage Vofs is controlled by the control voltage Vcnt input to the offset circuit 20.

The PWM signal generator 14 is a pulse width modulator and includes a triangular wave oscillator 26 and a voltage comparator 24. The triangular wave oscillator 26 generates a voltage of a saw tooth waveform of a regular frequency. The voltage comparator 24 compares an output voltage Vsaw of the triangular wave oscillator 26 and the offset error voltage Voe. When Vsaw>Voe, the voltage comparator 24 outputs a high level. When Vsaw<Voe, the voltage comparator 24 outputs a low level.

As a result, a signal Vpwm output from the voltage comparator 24 is a pulse width modulated signal in which a high level and a low level alternate (hereinafter, referred to as a PWM signal). In other words, the duty ratio (the ratio between the high and low level periods) of the PWM signal Vpwm is determined on the basis of the offset error signal Voe.

The step-down converter 10 is a synchronous rectified switching regulator which lowers the input voltage Vin fed to the input terminal 102 and delivers the lowered voltage to the output terminal 104. The input and output of the step-down converter 10 represent the input and output of the power supply apparatus 100. The step-down converter 10 includes a main switch SW1, a synchronous rectification switch SW2, an inductor L1, an output capacitor Co and a driver circuit 16. According to this embodiment, the main switch SW1 is a p-channel metal oxide semiconductor field effect transistor (MOSFET). The synchronous rectification switch SW2 is an n-channel MOSFET.

The p-channel MOSFET embodying the main switch SW1 has its source terminal connected to the input terminal 102 and its drain terminal connected to one end of the inductor L1. The n-channel MOSFET embodying the synchronous-rectification-switch SW2 has its source terminal connected to the ground and its drain terminal connected to the drain terminal of the p-channel MOSFET embodying the main switch SW1. An output from the driver circuit 16 is input to the gate terminal of each of the MOSFETs.

In the step-down mode, the driver circuit 16 turns off the main switch SW1 and turns on the synchronous rectification switch SW2 while the PWM signal Vpwm remains high. While the PWM signal Vpwm remains low, the driver circuit 16 turns on the main switch SW1 and turns off the synchronous rectification switch SW2. By alternately turning on and off the two switches SW1 and SW2 in accordance with the PWM signal, the operation as switching regulator, in which energy conversion occurs via the inductor L1, is achieved. The inductor L1 and the output capacitor Co constitute an output filter. A dc voltage obtained by lowering the input voltage Vin is output from the output terminal 104.

The driver circuit 16 receives the control voltage Vcnt for switching between the two modes. In the bypass mode of operation, the driver circuit 16 turns off both the main switch SW1 and the synchronous rectification switch SW2.

Since the PWM signal Vpwm controlling the on and off of the two switches SW1 and SW2 of the step-down converter 10 is determined in accordance with the error voltage Voe obtained by feeding back the output voltage Vout, tho output voltage Vout is maintained at a constant level defined by the reference voltage Vref.

The bypass switch SW3 is a p channel MOSFET receiving the control voltage Vcnt at its gate terminal. The bypass switch SW3 is turned on, i.e., drain-source conduction is achieved, when the gate-source voltage exceeds a threshold voltage. The source terminal of the bypass switch SW3 is connected to the input terminal 102 and the drain terminal thereof is connected to the output terminal 104. Accordingly, when the MOSFET is turned on, the input terminal 102 and the output terminal 104 conduct. A voltage practically identical to the input voltage Vin is delivered to the output terminal. Strictly speaking, the voltage delivered to the output terminal 104 is slightly lower than the input voltage Vin due to a voltage drop determined by the on-resistance Ron of the MOSFET. As a result of the bypass switch SW3 being turned on, the bypass mode is achieved.

A description will now be given to the operation of the power supply apparatus 100 with the above-described structure. The following description concern a case where the apparatus is switched from the step-down mode to the bypass mode At a given point of time and then returned to the step-down mode.

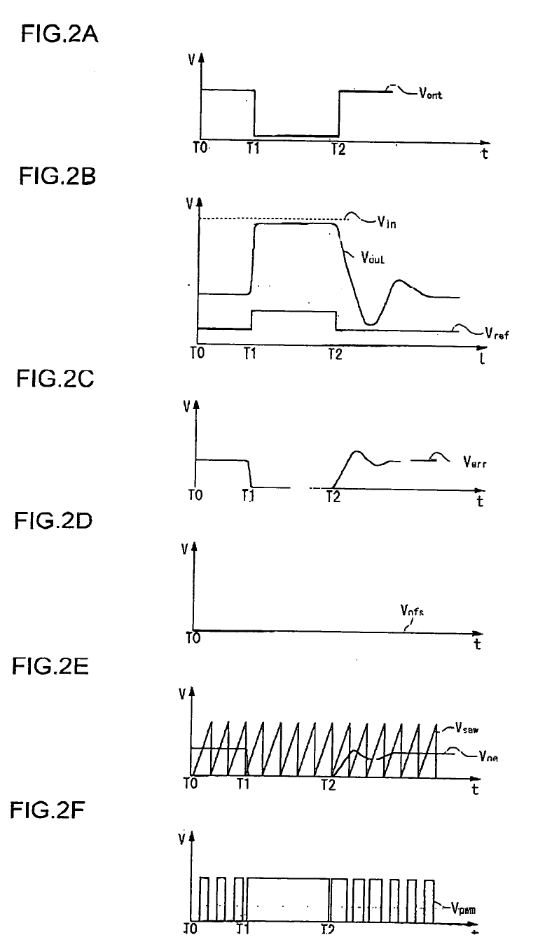

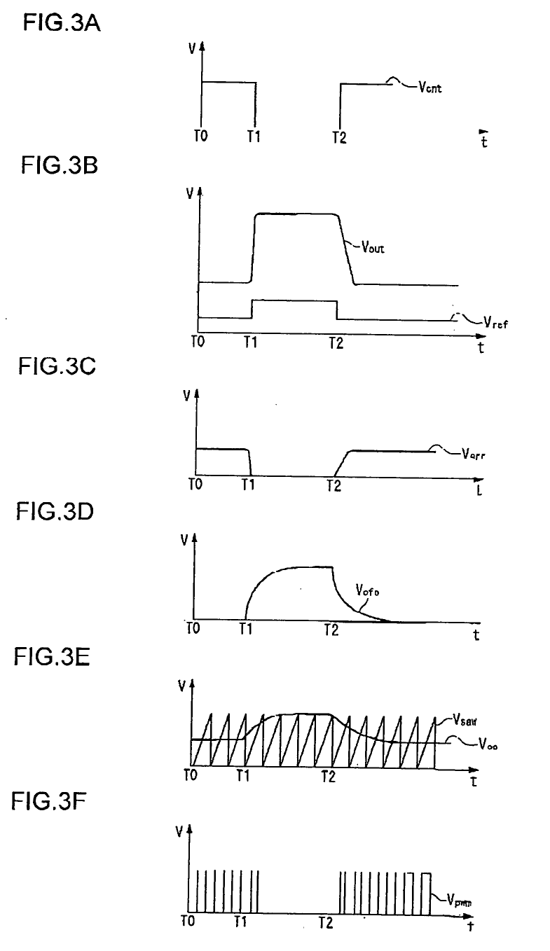

In order to fully elucidate the function according to the embodiment for stabilizing the output, a description will first be given of a case where the off set circuit 20 is not operated. FIGS. 2A-2F show time waveforms of voltages occurring at the respective terminals when the offset function of the power supply apparatus 100 is not activated. In FIGS. 2A-2F and in FIGS. 3A-3F, the scale of the time axis is different from that of the actual time axis so that the chart is easily viewable.

FIG. 2A shows a time waveform to the control voltage Vcnt. In an interval between tine T0 and time T1, the control voltage Vcnt of a high level that approximate the level of the input voltage Vin is input. In this interval, the gate-source voltage of the bypass switch SW3 is lower than the threshold voltage. Therefore, the MOSFET is turned off so that the power supply apparatus 100 is operated in the step-down mode.

FIG. 2B illustrates the reference voltage Vref and the output voltage Vout. In the interval between time T0 and time T1 for the step-down mode, the output voltage Vout and the reference voltage Vref are controlled such that Vout−Vref×(R1+R2)/R2 holds. FIG. 2B illustrates an example where (R1+R2)/R2=3.

FIG. 2C shows a lime waveform of the error voltage Verr. In the interval between time T0 and time T1, the error voltage Verr in maintained at a practically constant level such that Vout=Vref×(R1+R2)/R2 holds. FIG. 2D shows a time waveform of the offset voltage Vofs, an output of the offset circuit 20. FIG. 2E shows time waveforms of the offset error voltage Voc, which is a sum of the error voltage. Verr and the offset voltage Vofs, and of the triangular signal Vsaw. When the offset circuit 20 is not operated, the offset voltage Vofs remains 0 so that the Voe-Verr holds. FIG. 2F shows an output waveform of the PWM signal generator 14, which is determined by the offset error voltage Voe and the triangular voltage Vsaw of FIG. 2E.

When the control voltage Vcnt is lowered at time T1 as illustrated in FIG. 2A, the p-channel MOSFET embodying the bypass switch SW3 is turned on so that the apparatus makes a transition to the bypass mode. Concurrently with this, the control voltage Vcnt controls the driver circuit 16 so that the main switch SW1 and the synchronous rectification switch SW2 are both turned off.

When the bypass switch SW3 is turned on, the output voltage Vout of the power supply apparatus 100 rises to the level practically identical to the input voltage Vin, as illustrated in FIG. 2B.

In an interval between time T1 and time T2, the step-down converter 10 is bypassed so that Vout=Vref×(R1+R2)/R2 does not hold. As illustrated in FIGS. 2C and 2E, the error voltage Verr and the offset error voltage Voe are lowered to a level close to UV. As a result, the duty ratio of the PWM signal Vpwm is 100% In the interval between time T1 and time T2, as illustrated in FIG. 2F.

When the control voltage Vcnt is brought to a high level again at time T2, the bypass switch SW3 is turned off and a return to the step-down mode is designated. When the control voltage Vcnt is brought to a high level, the driver circuit 16 resumes its switching operation involving the main switch SW1 and the synchronous rectification Switch SW2, in accordance with the PWM signal Vpwm.

At time T2, the PWM signal Vpwm is at a high level as illustrated in FIG. 2F so that the synchronous rectification switch SW2 is turned on. At time T2, the drain terminal of the n-channel MOSFET embodying the synchronous rectification switch SW2 is fixed at a high voltage that approximates the input voltage Vin. Consequently, the synchronous rectification switch SW2 is fully turned on so that a large current is temporarily drawn from the output capacitor C0 via the inductor L1 and the synchronous rectification switch SW2. Therefor, the output voltage Vout defined by the charge built up in the capacitor Co is reduced abruptly due to the large current, as illustrated in FIG. 2B, causing undershoot to occur. Thereafter, the error voltage Verr is adjusted by the feedback operation of the regulator 12. The output voltage Vout approaches Vout=Vref×(R1+R2)/R2, accompanied by ringing.

As described above, if the offset circuit 20 is not operated, the output becomes unstable when the apparatus is switched from the bypass mode to the step-down mode. A relatively long period of time is required until the output is stabilized.

A description will now he given, with reference to FIGS. 3A-3F, of a case where the offset circuit 20 of the regulator 12 of the power supply apparatus 100 according to the embodiment is operated. FIGS. 3A-3F show time waveforms of voltages occurring at the respective terminals when the offset function of the power supply apparatus 100 is activated. In an interval between time T0 and time T1, the apparatus is in the step-down mode of operation in which the output voltage Vout is three times the reference voltage Vref. In this interval, the time waveforms occurring at the respective nodes are the same as those of FIGS. 2A-2F.

At time T1, the control voltage Vcnt switches the apparatus into the bypass mode. As illustrated in FIG. 3B, the output voltage Vout is rapidly raised to a level approaching the input voltage Vin the moment the bypass switch SW3 is turned on. Concurrently with this, the control voltage Vcnt controls the driver circuit 16 so that the main switch SW1 and the synchronous rectification switch SW2 are both turned off.

As illustrated in FIG. 3C, in the interval between time T1 and time T2, the error voltage Verr of a level practically identical to the level of FIG. 2C is output. The offset circuit 20 outputs the offset voltage Vofs illustrated in FIG. 3D in synchronization with the control voltage Vcnt. The offset voltage Vofs grows gradually from time T1 and remains constant subsequently. The regulator 12 outputs a sum of the offset voltage Vofs and the error voltage Verr as the error voltage Voe illustrated in FIG. 3E. The offset voltage Voe is higher than the level of FIG. 2E by the offset voltage Vofs.

The PWM signal generator 14 outputs the PWM signal Vpwm illustrated in FIG. 3F, in accordance with the offset error voltage Voe and the triangular signal Vsaw. As a result of the error voltage Verr being offset, the PWM signal generator 14 outputs the PWM signal Vpwm with a 0% duty ratio in the period between time T1 and time T2 of the bypass mode.

At time T2, tho control voltage Vcnt controls the apparatus to return to the step-down mode. Since the PWM signal Vpwm is at a low level at time T2, the driver circuit 16 resumes the switching operation involving the main switch SW1 and the synchronous rectification switch SW2 in a state in which the synchronous rectification switch SW2 is completely turned off. Subsequently, as illustrated in FIG. 3D, the offset voltage Vofs is gradually lowered so that the duty ratio of the PWM signal Vpwm is gradually increased accordingly. Therefore, the synchronous rectification switch SW2 is not abruptly turned on but is gradually turned on. Consequently, following the switch to the step-down mode at time T2, the charge built up in the output capacitor Co is prevented from being drawn out excessively via the synchronous rectification switch SW2. Therefore, the output voltage Vout is made to vary in a stable manner.

As described, in the power supply apparatus 100 according to the embodiment, offsetting of the error voltage Verr is enforced by the offset circuit 20 while the apparatus is in the bypass mode of operation. Since the synchronous rectification switch SW2 starts its operation in an off state when the apparatus is switched to step-down mode, the charge built up in the output capacitor Co is prevented from being drawn out excessively at switching. Accordingly, overshoot of the output voltage Vout is prevented.

Further, by ensuring that the offset voltage Vofs is gradually lowered in a transition from the bypass mode to the step-down mode, the synchronous rectification switch SW2 is gradually brought from an off state to an on state. Accordingly, the output voltage Vout is promptly stabilized at a value defined by the reference voltage Vret.

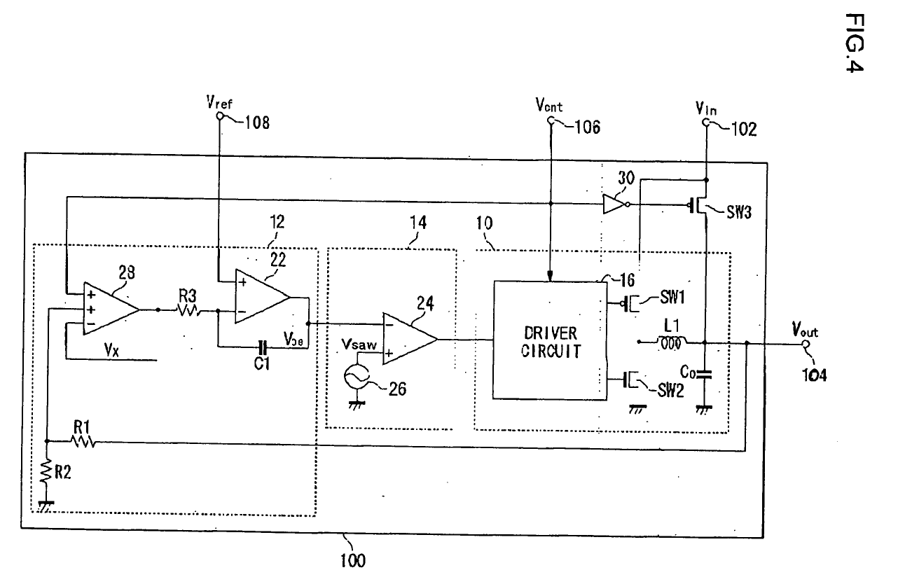

FIG. 4 is a detailed circuit diagram illustrating the structure of the power supply apparatus 100 according to the embodiment and illustrates an example of circuit in which the regulator 12 is provided with the off set function. The structure and operation of the PWM signal generator 14 and the step-down converter 10 are the same as those of FIG. 1 so that the description thereof is omitted.

The output voltage Vout multiplied by a gain of R2/(R1|R2) by resistor-based division and the control voltage Vcnt are respectively fed lo the two non-inverting inputs of an error amplifier 28. The inverting input is connected to the output so that the error amplifier 28 can he considered to function as a voltage follower outputting a sum of voltages input to the two non-inverting inputs. The control voltage Vcnt corresponds to the offset voltage that applies an offset to the error voltage. Therefore, the error amplifier 21 adds the offset voltage to the output voltage Vout of the step-down converter 10 and outputs the resultant voltage.

An error amplifier 22, a resistor R3 and a capacitor C1 constitute an integrator that integrates differences between an output voltage Vx of the voltage follower and the reference voltage Vref and outputs the voltage Voe. The resistor R3 is provided between the inverting input of the error amplifier 22 and the output to the error amplifier 28. The capacitor C1 is provided between the output and the inverting input of the error amplifier 22. The integrator is comprised of an operational amplifier for amplifying a differential voltage between the output voltage Vx of the error amplifier 28 and the reference voltage Vref, and a filter circuit that filters off low-frequency components of the output voltage Voe to the operational amplifier. The output voltage Voe of the error amplifier 22 is input to the PWM signal generator 14 that generates the PAW signal Vpwm.

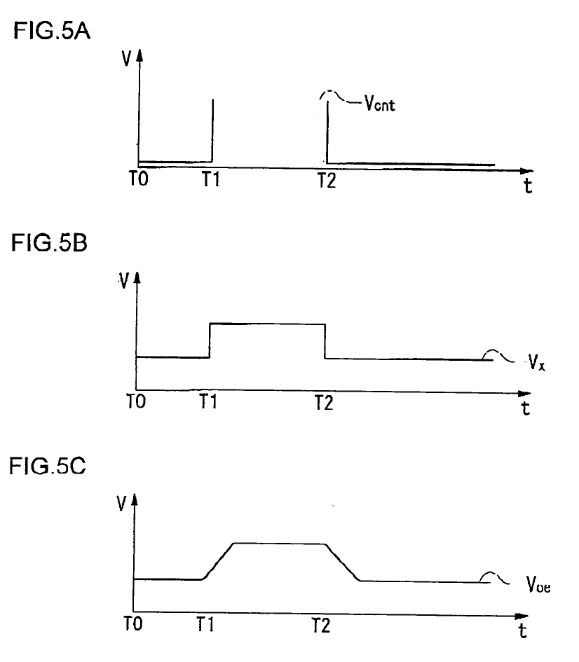

A description will now be given, with reference to FIG. 5, of the operation of the power supply apparatus 100 illustrated in FIG. 4 with the above-described structure. FIGS. 5A-5C only illustrates top control voltage Vcnt, then voltage Vx and the offset error voltage Voe. For the other voltages, reference is made to FIGS. 3A-3F as appropriate.

In an interval between time T1 and time T2, the control voltage Vcnt is at a low level as illustrated in FIG. 5A. Since the control voltage Vcnt is inverted by an inverter 30, the bypass switch SW3 is turned off and the apparatus is operated in the step-down mode. The error amplifier 28 functioning as a voltage follower outputs the voltage Vx defined by Vout×(R1+R2)/R2, as illustrated in FIG. 5B.

When the control voltage Vcnt is brought to a high level at time T1, the control voltage Vcnt is inverted into a low level by the inverter 30 so that the bypass switch SW3 is turned on. The apparatus is switched from the step-down mode to the bypass mode. Concurrently with this, the control voltage Vcnt controls the driver circuit 16 so that the main switch SW1 and the synchronous rectification switch SW2 are both turned off. When the control voltage Vcnt is brought to a high level, the voltage Vx of the error amplifier 28 is offset, as illustrated in FIG. 5B. The offset error voltage Voe obtained by integrating the voltage Vx by the error amplifier 32 is increased gradually from time T1 and is subsequently settled at a constant value, as illustrated in FIG. 5C.

At time T2, the control voltage Vcnt is brought to a low level again so that the bypass switch SW3 is turned off, designating a return to the step-down mode. When the control voltage Vcnt is brought to a low level, the driver circuit 16 resumes its switching operation involving the main switch SW1 and the synchronous rectification switch SW2, based on the PWM signal Vpwm.

When the control voltage Vcnt is brought to a low level at time T2, the error amplifier 28 no longer applies an offset so that the voltage Vx is decreased with the control voltage Vcnt as illustrated in FIG. 5B. The output Voe of the integrator constituted by the error amplifier 22 is gradually decreased as illustrated in FIG. 5C as the voltage Vx varies. Thus, the regulator 12 of the power supply apparatus 100 illustrated in FIG. 4 is capable of generating a waveform similar to that of the offset error voltage Voe illustrated in FIG. 3E. A PWM signal similar to that of FIG. 3F is obtained.

Since the PWM signal Vpwm is at a high level at time T2, the driver circuit 16 resumes its switching operation involving the main switch SW1 and the synchronous rectification switch SW2 in a state in which the synchronous rectification switch SW2 is completely turned off. Subsequently, as illustrated in FIG. 3F, the duly ratio of the PWM signal Vpwm is gradually increased. Accordingly, the synchronous rectification switch SW2 is gradually brought from an off state to an on state. As a result, following the switch to the step-down mode at time T2, the charge built up in the output capacitor Co is prevented from being drawn out excessively via the synchronous rectification switch SW2. Therefore, the output voltage Vout is made to vary in a stable manner.

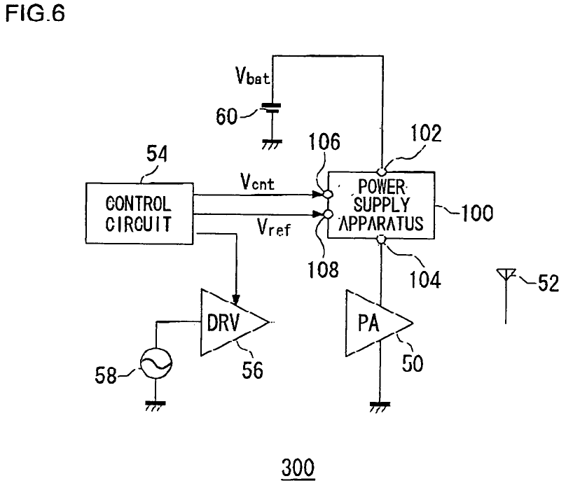

FIG. 6 illustrates the structure of a power amplifier apparatus 300 for a cell phone produced by connecting a power amplifier 50 to the power supply apparatus 100 according to the embodiment. The power amplifier apparatus 300 includes the power supply apparatus 100, the power amplifier 50, an antenna 52, a driver circuit 56, a control circuit 54 and a modulator 50.

The modulator 58 outputs a modulation signal with practically constant power on a continuous basis. The modulation signal is input to the driver circuit 56. The driver circuit 56 amplifies the modulation signal output from the modulator 58 and outputs the amplified signal to the power amplifier 50. The gain of the driver circuit 56 is variable.

The power amplifier 50 amplifies the output signal from the driver circuit 56 and outputs the amplified signal to the antenna 52. The power supply voltage of the power amplifier 50 is supplied from the power supply apparatus 100 and is regulated in accordance with the operating condition.

The power supply apparatus 100 lowers the voltage input to the input terminal 102 and outputs the lowered voltage from the output terminal 104. As described before, the power supply apparatus 100 switchably uses the step-down mode and the bypass mode. A battery 60 is connected to the input terminal 102 of the power supply apparatus 100. The input voltage Vin is the battery voltage Vbat. It will be assumed that the battery voltage is 3.5V.

The control circuit 54 is a circuit for controlling the whole power amplifier apparatus 300. The control circuit 54 outputs the reference voltage Vref and the control voltage Vcnt to the power supply apparatus 100.

A description will now be given of the operation of the power amplifier apparatus 300 with the above-described structure. In the power amplifier apparatus 300, the power supply voltage necessary in the power amplifier 50 depends on the output power from the antenna. More specifically, when a terminal is far from a base station and requires a high-power output, a power supply voltage of about 3.5V is necessary. When the terminal is close to the base station and requires only a low-power output, a voltage of 1.0V or less is necessary. That is, the output voltage of the power supply apparatus 100 is determined by the output power of the power amplifier 50.

The control circuit 54 regulates input power to the power amplifier 50 by controlling the gain of the driver circuit 56 in accordance with the distance from the base station. Concurrently with this, the control circuit 54 controls the output voltage of the power supply apparatus 100 by the control voltage Vcnt and the reference voltage Vref.

It will be assumed that the power supply voltage required by the power amplifier 50 is 1V when a cell phone is near the base station. The control circuit 54 sets up the step-down mode in the apparatus, using the control voltage Vcnt and regulates the output voltage by the reference voltage Vref. It will be assumed that a need arises to increase the output voltage as a result of the cell phone moving while in communication and is removed from the base station. When the power supply voltage required by the power amplifier in this condition is 3.5V, the control circuit 54 switches the power supply apparatus 100 to the bypass mode by the control voltage Vcnt. The power supply apparatus 100 outputs the battery voltage Vbat, the input voltage, unmodified. Therefore, 3.5V is supplied to the power amplifier.

As the distance from the base station is decreased as a result of the cell phone moving, the power supply voltage required by the power amplifier of the power amplifier apparatus 300 will be lowered again so that the apparatus will be switched to the step-down mode. The power supply apparatus 100 according to the embodiment operates effectively in this situation and supplies the power supply voltage to the power amplifier in a stable manner. This will ultimately stabilize the output power of the power amplifier apparatus 300.

The embodiment is only illustrative in nature and it will be obvious to those skilled in the art that variations in constituting elements and processes are possible within the scope of the present invention.

While a p-channel MOSFET and an n-channel MOSFET are used as the main switch SW1 and the synchronous rectification switch SW2, respectively, according to the embodiment, other forms of implementation are possible. By changing the logic for driving the gate voltage by the driver circuit 16, both switches may be implemented by n-channel MOSFETs Alternatively, bipolar transistors may be used in place of the MOSFETs. The requirement is that the transistors operate as a switching regulator. A variety of other transistors including metal semiconductor FETs (MESFET) may be used if the GaAs process can be used. Similarly, the bypass switch SW3 may be implemented by any of a variety of transistors. Selection of a component may be determined in accordance with the circumstances including the semiconductor fabrication process used to design the circuit, the circuit scale and the like.

All of the components constituting the power supply apparatus 100 according to the embodiment may be integrated. Alternatively, some of the components may be formed as discrete parts. The area subject to integration may be determined considering the cost, occupied area or the like.

While the bypass switch SW3 is described as being used as a voltage generating circuit for outputting a voltage higher than the step-down converter 10, other implementations are possible. Any circuit may be used in this invention as long as it is capable of generating a higher output voltage than the step-down converter. For example, a step-up converter may be used in place of the bypass switch SW3 as a voltage generating circuit provided in a route separate from the step-down converter 10.

While the PWM scheme described as being used to switchably operate the main switch SW1 and the synchronous rectification switch SW2 according to the embodiment, other schemes including the pulse frequency modulation scheme or the pulse density modulation scheme may be employed.

While the power supply apparatus 100 is described as being used in the power amplifier apparatus 300 in the embodiment, the power supply apparatus 100 may be used to power supply circuits in general that lower an input voltage for use.

While the preferred embodiments of the present invention have been described using specific terms, such description is for illustrative purposes only, and it is to be understood that changes and variations may be made without departing from the spirit or scope of the appended claims.

What is claimed is:

1. A power supply apparatus comprising:
a synchronous rectified step-down converter in which a main switch and a synchronous rectification switch are alternately turned on and off; and
a voltage generating circuit provided in a route separate from the step-down converter, wherein
one of the step-down converter and the voltage generating circuit is selected to output a desired voltage, and the step-down converter turns the synchronous rectification switch off while the voltage generating circuit is being selected.

2. A power supply apparatus comprising:
a synchronous rectified step-down converter in which a main switch and a synchronous rectification switch are alternately turned on and off;
a voltage generating circuit which outputs a voltage higher than the step-down converter;
a regulator which outputs an error voltage so that an output voltage of the step-down converter approximates a predetermined reference voltage; and
a pulse width modulator which varies a duty ratio with which the main switch and the synchronous rectification switch are turned on and off, in accordance with the error voltage, wherein
one of the step-down converter and the voltage generating circuit is selected to output a desired voltage, and the regulator offsets the error voltage while the voltage generating circuit is being selected, in a direction in which the synchronous rectification switch is turned off.

3. The power supply apparatus according to claim 2, wherein the voltage generating circuit includes a bypass circuit which short-circuit an output terminal of the step-down converter to an input terminal thereof.

4. The power supply apparatus according to claim 2, wherein the regulator is provided with an offset circuit which offsets the error voltage in synchronization with a signal for switching from between the step-down converter and the voltage generating circuit.

5. The power supply apparatus according to claim 4, wherein the offset circuit gradually decreases the amount of offset applied to the error voltage in response to the switching from the voltage generating circuit to the step-down converter.

6. The power supply apparatus according to claim 2, wherein the regulator comprises:
a first operational amplifier which adds a predetermined offset voltage to the output voltage of the step-down converter and outputs a resultant voltage;
a second operational amplifier which amplifies a difference between an output voltage of the first operational amplifier and the reference voltage; and
a filter circuit which removes low-frequency components of an output voltage of the second operational amplifier.

7. The power supply apparatus according to claim 6, wherein the offset voltage is generated based on a signal which switches between the step-down converter and the voltage generating circuit.

8. The power supply apparatus according to claim 6, wherein the filter circuit comprises:
a resistor provided between a first input terminal of the second operational amplifier and the first operational amplifier; and
a capacitor provided between an output terminal of the second operational amplifier and a second input terminal thereof.

9. A power amplifier apparatus comprising:
a power amplifier for power amplification; and
a power supply apparatus according to claim 1 which supplies power supply voltage to the power amplifier.

10. A power amplifier apparatus comprising:
a power amplifier for power amplification; and
a power supply apparatus according to claim 2 which supplies power supply voltage to the power amplifier.

11. A power amplifier apparatus comprising:
a power amplifier for power amplification; and,
a power supply apparatus according to claim 3 which supplies power supply voltage to tho power amplifier.

12. A power amplifier apparatus comprising:
a power amplifier for power amplification; and
a power supply apparatus according to claim 4 which supplies power supply voltage to the power amplifier.

13. A power amplifier apparatus comprising:
a power amplifier for power amplification; and
a power supply apparatus according to claim 5 which supplies power supply voltage to the power amplifier.

14. A cell phone comprising the power amplifier apparatus according to claim 9.

15. A cell phone comprising the power amplifier apparatus according to claim 10.

16. The cell phone comprising the power amplifier apparatus according to claim 11.

17. The cell phone comprising the power amplifier apparatus according to claim 12.

18. The cell phone comprising the power amplifier apparatus according to claim 13.
